(19) United States
(12) Patent Application Publication
(10) Pub. No.: US 2013/0275184 A1
(43) Pub. Date: Oct. 17, 2013

(54) EXTERNALIZED DECISION MANAGEMENT IN BUSINESS APPLICATIONS

(71) Applicants: ASIT DAN, PLEASANTVILLE, NY (US); MIKE A. MARIN, LAGUNA HILLS, CA (US)

(72) Inventors: ASIT DAN, PLEASANTVILLE, NY (US); MIKE A. MARIN, LAGUNA HILLS, CA (US)

(73) Assignee: INTERNATIONAL BUSINESS MACHINES CORPORATION, ARMONK, NY (US)

(21) Appl. No.: 13/444,471

(22) Filed: Apr. 11, 2012

(51) Int. Cl. G06Q 10/06

(52) U.S. Cl. 705/7.37

(57) ABSTRACT

Within a business process, a decision reference can be defined at an insertion point. The decision reference can be associated with one of a plurality of different decision modes. Each decision mode can indicate a different process for selecting one or more activities of the business process to be performed according to a result of a decision service to be implemented for the decision reference. A description file can be generated for the decision reference specifying, at least in part, the associated decision mode.

### BACKGROUND

Business applications often rely upon different decision making technologies. The persons responsible for development of the business applications, however, are not usually familiar with the decision making technologies that are available. For example, business analysts and/or software developers typically are not familiar with the range of available complex decision making technologies such as business rules, predictive analysis, analytics, business intelligence, reporting tools, or the like.

Decision making technologies, whether relating to the selection of a particular technology that is suited for a specific task or the use of that technology once selected, has been the province of experts in the relevant field. The need for expert involvement and the unfamiliarity with decision making technologies on the part of those responsible for business application development have made the integration of decision making technologies into business applications difficult to manage.

### BRIEF SUMMARY

One or more embodiments disclosed within this specification relate to business process applications and, more particularly, to using decision management for business process application development. Examples of business process application development tools can include, but are not limited to, standards-based business process modeling tools (e.g., those using Business Process Execution Language (BPEL), Business Process Modeling Notation (BPMN), etc.), case management, packaged applications with configurable transactions, or the like.

An embodiment can include a method. The method can include creating a decision reference at an insertion point within a business process and associating, using a processor, the decision reference with one of a plurality of different decision modes. Each decision mode can indicate a different process for selecting one or more activities of the business process to be performed according to a result of a decision service to be implemented for the decision reference. A decision description file for the decision reference can be generated that specifies, at least in part, the associated decision mode.

Another embodiment can include a system. The system can include a processor configured to initiate executable operations including generating a decision reference at an insertion point within a business process and associating the decision reference with one of a plurality of different decision modes. Each decision mode can indicate a different process for selecting one or more activities of the business process to be performed according to a result of a decision service to be implemented for the decision reference. A decision description file can be generated for the decision reference specifying, at least in part, the associated decision mode.

Another embodiment can include a computer program product. The computer program product can include a computer readable storage medium having stored thereon program code that, when executed, configures a processor to perform executable operations. The executable operations can include generating a decision reference at an insertion point within a business process and associating the decision reference with one of a plurality of different decision modes. Each decision mode can indicate a different process for selecting one or more activities of the business process to be performed according to a result of a decision service to be implemented for the decision reference. A decision description file for the decision reference can be generated that specifies, at least in part, the associated decision mode.

### BRIEF DESCRIPTION OF THE SEVERAL VIEWS OF THE DRAWINGS

FIG. 1 is a block diagram illustrating an architecture for developing a business process in accordance with an embodiment disclosed within this specification.

FIG. 2 is a block diagram illustrating an exemplary data processing system in accordance with another embodiment disclosed within this specification.

FIG. 3 is a flow chart illustrating a method of application development in accordance with another embodiment disclosed within this specification.

FIG. 4 is a flow chart illustrating a method of managing decision service creation in accordance with another embodiment disclosed within this specification.

FIG. 5 is a block diagram illustrating an architecture for application runtime in accordance with another embodiment disclosed within this specification.

FIG. 6 is a flow chart illustrating a method implementing a business process in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the embodiments of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments disclosed within this specification relate to business process applications and, more particularly, to using decision management for business process application development. In accordance with the inventive arrangements disclosed within this specification, business process creation can be separated from decision management, which can include, for example, decision design and implementation. As such, modeling of the business process is independent and separate from modeling of the decision.

One or more business processes can be created using a business process development tool. When a decision is required in the context of the business process being created, the decision can be defined in terms of various attributes including, for example, a decision mode. In general, the decision mode indicates how the result of the decision is consumed by the business process when executed, e.g., at runtime.

A description of the decision needed by the business process can be provided to one or more other developers that can implement a decision service in accordance with the description generated by the business process development tool. The decision service itself, however, is not implemented using the business process development tool. In this manner, decision services that are required for implementation of a business process can be developed independently of the underlying business process.

Further, at runtime, the business process can be executed in a computing environment that is separate from the computing environment in which the decision service(s) are implemented. This decoupling, or separation, of business processes from decision services allows business processes to be defined more readily. Further, those users responsible for development of the business processes need not have an understanding of the various technologies available for implementing the decision service.

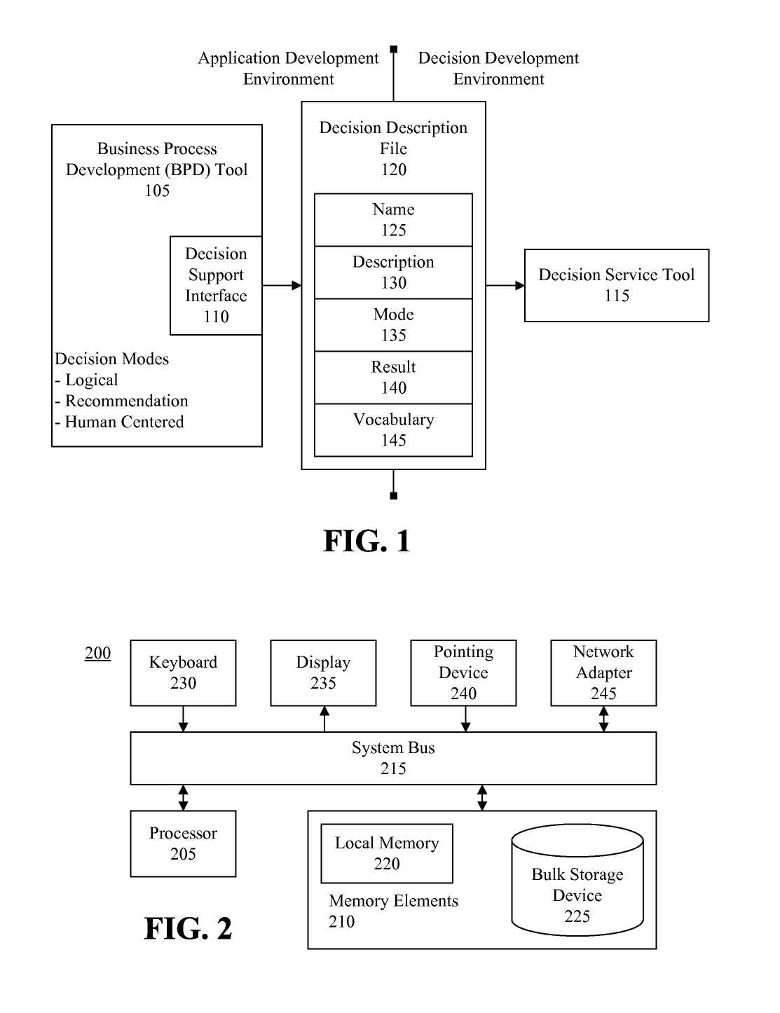

FIG. 1 is a block diagram illustrating an architecture for developing a business process in accordance with an embodiment disclosed within this specification. As shown, a business process development (BPD) tool 105 is provided in an application development environment, e.g., a first computing environment. A decision service tool 115 is provided within a decision development environment, e.g., a second and different computing environment. It should be appreciated that one or more decision service tools can be provided, without limitation.

In one aspect, the application development environment can be independent of the decision development environment. For example, each environment can represent a different data processing system, e.g., a different collection of one or more computers or servers, in which the respective tool located in that environment can execute. Accordingly, the users of BPD tool 105 can be different from users of decision service tool 115.

In general, BPD tool 105 can be used to create or define a business process that can be output in a programmatic form. For example, the business process can be output in the form of an executable application, a markup language file, a schema, or the like. In one aspect, BPD tool 105 can utilize a rules language, e.g., a business rules language, to define the business process and resulting programmatic representation thereof. BPD tool 105, however, can be implemented in other forms. Further exemplary implementations of BPD tool 105 can include, but are not limited to, standards-based business process modeling tools (e.g., those using Business Process Execution Language (BPEL), Business Process Modeling Notation (BPMN), etc.), case management, packaged applications with configurable transactions, or the like.

A business process, in general, refers to a collection of related, structured activities or tasks that produce a specific service, product, or achieve a particular goal. For example, a business process can include a chain of events in an enterprise, e.g., from purchase to supply or from manufacture to sales. Such events can also be services provided by individual system components. The business process can be created by, or specified within, BPD tool 105 as a flow or a sequence of activities with interleaving decisions in which the particular path through the sequence of activities, or activities that are selected, depends upon the result(s) of the decisions.

As used within this specification, it should be appreciated that the phrase “business process” refers to a programmatic representation of an actual business process as determined and generated using BPD tool 105. Further, to the extent that a business process is an executable application or other format that can be emulated or simulated using a tool or runtime engine, the phrases “business application” and “business process” may be used interchangeably within this specification.

One example of a business process can be the handling of an insurance claim. In processing the insurance claim, various decision points exist in the claim handling process (e.g., business process) that determine the particular processing, e.g., activities, to which the insurance claim is subjected. For instance, in some cases a decision may need to be performed as to whether there is any potentially deceptive activity taking place in relation to the claim. The activities of the business process that are performed can depend upon that decision.

Because decision services are developed using decision service tool 115 as opposed to BPD tool 105, the creation of decision services is decoupled from the creation of the business process. Further, the users of decision service tool 115 typically are different from the users of BPD tool 105. For example, the users of decision service tool 115 usually are subject matter, or domain, experts with respect to the decision being made as opposed to business personnel (e.g., generalists) or software developers. Thus, decision service creation becomes a separate endeavor that is decoupled from business process development.

Referring to the prior example, where the general procedure for handling an insurance claim can be defined within BPD tool 105, the determination of whether any deception may or may not exist with regard to the insurance claim is a more complex and detailed decision that is more suitably left to an expert in the field. Thus, decision service 115 can be used to generate a decision service that determines whether a particular insurance claim is, or is potentially, deceptive.

A user, working with BPD tool 105, can define a business process. Decisions that are to be included within the business process can be identified, or specified, by the user to BPD tool 105. In identifying the decisions that are required to implement the business process, BPD tool 105 allows a user to specify the decision using a variety of different attributes to be described herein in further detail.

Each decision that is incorporated into the business process can be represented by a decision reference that is included at a particular insertion point, or location, within the business process. Each decision reference can be associated with a variety of different attributes that describe the decision that is to be made.

One attribute that can be associated with a decision reference is the decision mode. In general, the mode of a decision (e.g., decision mode or mode), indicates how a result of the decision is consumed, or utilized, by the business process. In this regard, the decision mode can be considered a special case of an attribute as described in greater detail within this specification.

Each different decision mode can indicate a different process for selecting one or more activities of the business process to be performed (e.g., at runtime) according to a result of the decision service to be implemented for the decision reference. Thus, the mode of a decision (or decision reference) further provides an indication of the type of output expected from the decision service that is to be implemented for the decision reference. The particular mode of a decision service can be any of a plurality of different varieties. In one aspect, the decision mode can be implemented as a first class abstraction for modeling consumption of decisions by BPD tool 105. Examples of the various decision modes that can be associated with a decision reference can include, but are not limited to, “logical,” “recommendation,” or “human centered.”

A decision service with a decision mode of “logical” returns a binary response such as “yes” or “no.” A logical mode decision service, for example, can be used by the business process to implement branching between two alternate, e.g., mutually exclusive, paths through the business process at runtime. The business process consumes a result of a logical mode decision service by, for example, determining or selecting one of two possible branch paths through the business process based upon the binary result that is returned from the decision service.

A decision service with a mode of “recommendation” returns a result in the form of a value within a range of possible values (e.g., a result not restricted to a binary value). The value can be one from within an enumerated range or continuum of 2, 3, 4, or more possible values. A recommendation mode decision service can be used, for example, to generate a score or other value in which the range of possible outcomes can be greater than two. A recommendation mode decision service also can be used in situations where the particular activities that are implemented based upon the result are not mutually exclusive, though the activities can be mutually exclusive in some cases if so desired.

The business process can consume a result of a recommendation mode decision service at runtime by comparing the result with one or more enumerated segments, i.e., sub-ranges, of the range of permissible values for results returned by the recommendation mode decision service. The particular segment in which the result falls, e.g., a first, second, third, fourth, etc., segment of the defined range can be used to indicate or select a particular path, or branch, through the business application.

For example, in consuming a result of a recommendation mode decision service at runtime, the business process typically compares the result with one or more of the segments to determine the particular segment in which the result falls. Given a result that meets or exceeds a specified threshold, for example, the business process can implement a set of one or more enumerated activities or tasks. The particular set of activities that are implemented depends upon the strength (e.g., size) of the value that is returned. The activities selected for implementation based upon a recommendation further can be performed in parallel.

In illustration, a result falling within a first segment can indicate that activities 1, 2, and 4 are to be performed. A result falling within a second segment can indicate that activities 1, 3, and 5 are to be performed. Accordingly, a result of a recommendation mode decision service allows the business process to select and implement a set of one or more activities, e.g., potentially parallel activities, based upon the strength of the result returned. The activities that are selected can be mutually exclusive among the segments or not.

A decision service with a mode of “human centered” returns a result that is interpreted by a human being. The result that is returned can be in any of a variety of human readable formats. For example, a report mode decision service can return a result in the form of a table, a graph, text, a chart, a recommendation, or the like. In general, whereas the result of a logical mode decision service or a recommendation mode decision service is consumed automatically by the business process at runtime, e.g., activities to be performed are implemented automatically according to the result, a human centered mode decision service returns a result that requires a human being review the result and manually select a path through the business process or manually select one or more activities to be performed at runtime. For example, typically the business process can be configured to provide a plurality of selectable options accompanying the result returned by a human centered mode decision service. An end-user at runtime can view the selectable options and select a suitable option (e.g., path) based upon a review of the result of the human centered mode decision service.

It should be appreciated that the type of report that can be generated by a human centered decision service can be one that is interactive in nature as opposed to a static type of report. For example, the report can allow drill down where the data can be represented in any of a variety of different ways or formats depending upon a user request at runtime. In illustration, a first high level report or chart can be displayed. Responsive to a selection of a particular portion of the report by an end-user, a more detailed view of the selected portion of the report (e.g., data) can be presented to the end-user. Using drill down, the end-user can view increasing levels of detail interactively prior to selecting one or more activities to be performed in the context of the business process.

For purposes of description and clarity, the term “user” is used to refer to users responsible for development, whether development of the business process or the decision service. The term “end-user” is used to refer to a user of the business process at or during runtime.

Whereas the embodiments disclosed within this specification allow a decision service to be described, but not implemented, within BPD tool 105, a conventional system would require the decision to be fully specified, e.g., actually realized, within the BPD tool itself. As such, the user responsible for creating the business process also must select the appropriate technology and tool for implementing the decision. Moreover, the user responsible for developing the business process would need to know the technology to be used to create the decision service and also define a specific interface for the service technology to interact with the business process. Further, in a conventional system, the decision can only be specified in the form of a general task that is not correlated with any attributes indicating the type of result returned by the decision service or the manner in which the result is consumed by the business process. A user creating a business process, for example, likely does not know the appropriate decision making technology to utilize in creating the decision service. Further, the user creating the business process would not likely know that some decision making technologies are better suited than others for making decisions depending upon the type of decision to be made, e.g., whether the decision relates to compliance, risk or opportunity, estimation, etc.

As shown, BPD tool 105 can include a decision support interface 110. Decision support interface 110 can be configured to generate a decision description file 120 for each of the decision references (e.g., decisions) that are defined or inserted into the business process being developed. Alternatively, multiple decisions can be specified within a single decision description file. In any case, decision description file 120 can include a plurality of attributes of a decision service that is to be developed and that is referenced by the decision reference inserted into the business process. Rather than explicitly defining exactly what and how the decision is to be made, an abstract description of the decision is generated in the form of decision description file 120. Decision description file 120 can be formatted according to any of a variety of conventions. In one example, decision description file can be specified in the form of an eXtensible Markup Language file or the like.

Examples of the attributes that can be specified within the decision description file 120 can include, but are not limited to, a name 125, a description 130, the mode 135 as previously described, a result 140, and a vocabulary 145. For example, name 125 can specify a name that can be used by the business process to invoke or call the decision service to be implemented in accordance with decision description file 120.

Description 130 can be a textual description of what the decision service is to do, e.g., indicate or specify the functionality to be performed, inputs to the decision service if known, outputs from the decision service, other descriptive information for a developer of the decision service, etc. In another aspect, description 130 can indicate a particular type of the decision that is to be implemented. For example, the type specified in, or by, description 130 can indicate whether the decision service is to make a policy type of decision, a risk or risk assessment type of decision, an opportunistic type of decision, an estimation, or the like.

Mode 135 can specify the mode of the decision service as previously described, e.g., the decision mode. Result 140 can specify the particular type of result, e.g., the response, expected by the business process from the decision service that performs the decision. In one aspect, mode 135 can indicate some information about result 140. For example, a logical mode decision service returns a binary value. A recommendation mode decision service returns a value from within a range. A human centered mode decision service returns human readable information. Thus, in one aspect, result 140 can provide explanatory data as to how the result is to be consumed by the business process.

For example, result 140 can indicate the particular binary values to be returned in the case of a logical mode decision service and the meaning of the values in terms of which branch or path is selected by each value to provide an indication of the business process branching that is to be performed. Result 140 can specify the allowed range of values for a recommendation mode decision service. For example, result 140 can indicate the various segments values and the subsequent interpretation of those segments, e.g., different thresholds to be applied in interpreting the result of a recommendation and the activities invoked by each segment. Result 140 can specify the particular data that is to be returned and the formatting of the data, e.g., tabular, pie chart, graph, recommendation, etc., in the case of a human centered mode decision service. In the case of a human centered mode decision service, result 140, for example, can indicate the particular options that are to be presented to the user concurrently with the result that is returned so that experts creating the decision service understand the decision to be made to better determine a manner of presentation or create drill down functionality.

In another aspect, one or more of the data items described can be provided in description 130. For example, information relating to how the result of the decision service is to be consumed in reference to particular activities to be performed and the interpretation of the result can be provided in description 130 as opposed to result 140.

Vocabulary 145 can specify the particular data items and types that are provided to the decision service from the application as input to invoke the decision service. A vocabulary, as used herein, can refer to a list of variables (fields, properties, etc.) that an application is using. For example, an insurance claim application may have the following vocabulary: customer, name, customer address, insured car plate, accident description, calculated accident cost, amount paid, etc. Accordingly, vocabulary 145 can specify data provided to, or otherwise made available to, the decision service from the business process upon invocation. Vocabulary 145 can specify, for example, particular values to be passed to the decision service at runtime, a reference to a particular vocabulary used by the business process that can be accessed by the decision service, or a combination thereof.

Referring to FIG. 1, users of BPD tool 105 no longer require familiarity with different types of decision making technologies in order to benefit from the incorporation of complex data analysis as part of a business process. The requirements for a particular decision service can be expressed through BPD tool 105 in the form of decision description file 120. The user of BPD tool 105 can specify the various attributes of the required decision, which can be output in the form of decision description file 120.

In one aspect, as illustrated in FIG. 1, decision description file 120 can be made directly available to a decision service tool 115 or the particular data processing system executing decision service tool 115. In another aspect, decision description file 120 can be published to a registry that includes a listing, e.g., plurality of decision description files, in which each entry or decision description file specifies a decision service that is needed by a business process and that is to be developed. Users of decision service tool 115 can consult the directory and look-up decision description files 120 that need to be fulfilled and begin development of a decision service in fulfillment of a particular decision description file in accordance with the attributes (requirements) specified therein.

Decoupling decision services from the business processes provides a scalable architecture. The requirements of business users are decoupled from decisions relating to the particular technology that is selected by the subject matter expert, e.g., user of decision service tool 115, to implement the decision service. Rather than contending with decision service development, users of BPD tool 105 can direct attention to development of the business process and define a clear interface that can be accessed by the decision services that are independently developed and subsequently called by the business process.

In one aspect, because decision service development is decoupled from development of the application, the particular technology and tool for implementing the decision service can be selected by the person that is responsible for developing the decision service and that has expertise in that area, as opposed to the persons responsible for development of the business process. An expert charged with developing the decision service, for example, can review decision description file 120 and select the particular technology to be used in creating the decision service, e.g., business rules, predictive analysis, analytics, business intelligence, reporting tools, or the like, and also the particular tool to be used as decision service tool 115. In another aspect, an additional system can be configured to interpret decision description file 120 and recommend a particular decision making technology and/or a decision service tool for use in creating the decision service.

The user (e.g., expert) can model the decision service and gather any additional details of the business requirements that may be needed to implement the decision service. As briefly noted, examples of available technologies for use in creating a decision service can include, but are not limited to, business rules that may be derived from a predictive model using analysis of past data, business rules directly specified by analysts, predictive models where test data sources can be selected followed by development of models using appropriate tools, analytics, etc. The predictive models can be validated and/or refined prior to deployment (availability to the business process). Accordingly, the particular type of decision service tool 115 that is to be used to create a decision service can be selected according to information included in decision description file 120.

When a decision service is generated, e.g., assembled, by decision service tool 115, the decision service can be published into a decision service registry that includes entries of available decision services that can be looked up or otherwise accessed by the business process. In another example, the decision service can be provided to the application for direct import into the business application. The architecture described with reference to FIG. 1 allows the business process generated by BPD tool 105 to be deployed independently of the decision services that are required by the business process when executed, e.g., at or during runtime of the business process.

FIG. 2 is a block diagram illustrating an exemplary data processing system 200 in accordance with another embodiment disclosed within this specification. System 200 can be used to implement the application environment and, thus, execute BPD tool 105 of FIG. 1. System 200, or a system similar thereto, can be used to implement the decision environment and, thus, execute decision service tool 115. System 200 further can be used to implement various other aspects of the embodiments to be described within this specification relating to runtime of the business process(es) and runtime of the decision services.

System 200 can include at least one processor 205 coupled to memory elements 210 through a system bus 215 or other suitable circuitry. As such, system 200 can store program code within memory elements 210. Processor 205 can execute the program code accessed from memory elements 210 via system bus 215. In one aspect, for example, system 200 can be implemented as a computer that is suitable for storing and/or executing program code. It should be appreciated, however, that system 200 can be implemented in the form of any system including a processor and memory that is capable of performing the functions and/or operations described within this specification.

Memory elements 210 can include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard drive or other persistent data storage device. System 200 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240 optionally can be coupled to system 200. The I/O devices can be coupled to system 200 either directly or through intervening I/O controllers. One or more network adapters 245 also can be coupled to system 200 to enable system 200 to become coupled to other systems, computer systems, remote printers, and/or remote storage devices through intervening private or public networks. Modems, cable modems, and Ethernet cards are examples of different types of network adapters 245 that can be used with system 200.

Memory elements 210 can store various applications and/or development tools (e.g., BPD tool 105, decision service tool 115, runtime version of the business process(es), runtime decision service(es)) in the form of program code as described within this specification. Upon execution of the program code, system 200 can be configured to initiate and/or perform the various operations described herein.

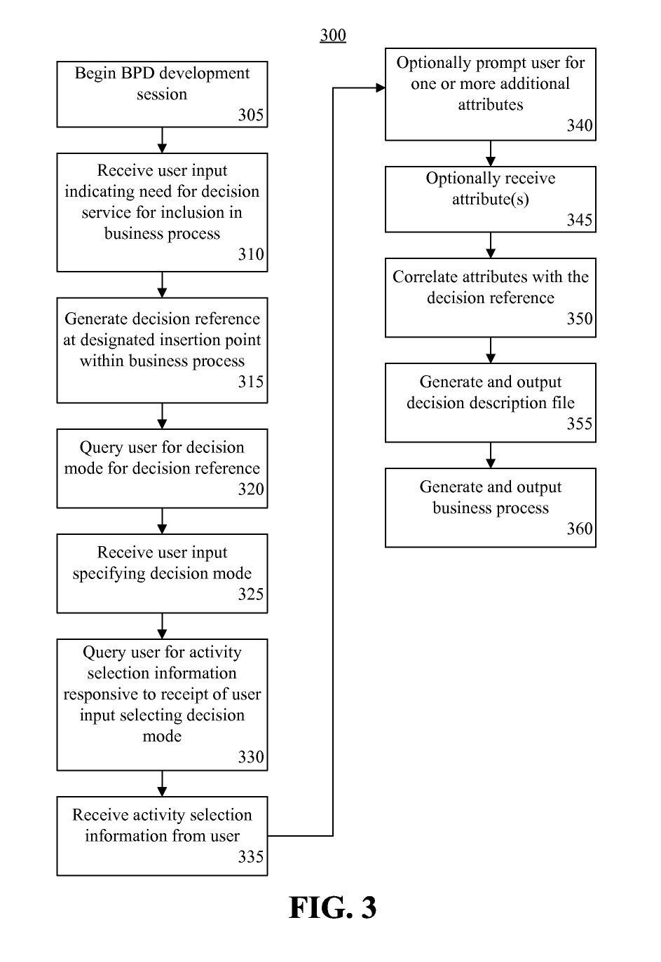

FIG. 3 is a flow chart illustrating a method 300 of application development in accordance with another embodiment disclosed within this specification. Method 300 can be implemented by a data processing system as described with reference to FIG. 2. For example, method 300 can be implemented by a data processing system executing a BPD tool as described with reference to FIG. 1 for developing a business application.

In step 305, the system can begin or initiate a BPD session, for example, at the request of a user. For instance, a user of a system can launch the BPD tool, e.g., an application development environment, use a software development kit, or the like, and begin a new project in which a business process can be developed. In step 310, the system can receive an input indicating a need for inclusion of a decision service.

In step 315, responsive to the user input, the system can generate a decision reference. The system can insert the decision reference at a designated location called an insertion point within the business process as specified by the user. The system allows the user to indicate the point of invocation for the decision service to be generated as indicated by the location of the decision reference within the business process. The decision reference can serve as an indicator that a decision service of the same name attribute is to be called or invoked when the business process is executed, e.g., during runtime.

In step 320, the system can query the user for a decision mode to be associated with the decision reference. For example, the system can present a user interface through which the user can select one of the various decision modes described within this specification and associated the selected decision mode with the decision reference. In step 325, responsive to the query, the system can receive a user input specifying the decision mode of the decision service to be implemented for the decision reference. As discussed, the decision mode can be specified as “logical,” “recommendation,” or “human centered.”

In step 330, responsive to receiving a user input specifying the selected decision mode, the system can query the user for activity selection information. Each decision mode can indicate a different process for selecting one or more activities of the business process to be performed according to a result of a decision service to be implemented for the decision reference. The system can prompt the user for activity selection information relating to the decision service according to the decision mode specified.

As discussed, the decision mode of the decision service specifies the manner in which the result from the decision service is to be consumed by the business process at runtime. In this regard, the particular activity selection data expected by the system to be provided from the user during development of the business process varies in accordance with the decision mode that is selected. The system can present a user interface that allows the user to provide the activity selection information as discussed herein. It should be appreciated that the particular interface that is presented, however, can vary in accordance with the decision mode of the decision service, particularly as the type of information that is expected from the user will vary with the decision mode.

In illustration, responsive to determining that the decision mode is logical, the system can request that the user indicate the two alternate branches among which the result of the decision service is used to select. The system further can request that the user to indicate or specify an association between the particular binary result returned and the branch selected by that value. For example, the system can present a flow chart type of interface or decision box representing the decision reference in which the user visually links available paths within the business process with the decision reference and associates each linked path with a binary value returned as a result.

Responsive to determining that the decision mode is a recommendation, the system can request that the user indicate one or more activities that can be selected for implementation. For example, the user can be asked to select one or more activities from a list of available activities in the business process. The system further can prompt the user to specify the segments (e.g., sub-ranges) to which the result returned by the decision service will be compared. In addition, the system can prompt the user to correlate each segment with one or more of the activities that have been selected from the list. Each activity selected from the list and correlated with a segment can be executed by the business process at runtime responsive to determining that the result of the decision service is within that segment. As noted, each activity can be exclusive to a segment or can be assigned or allocated to more than one segment. Activities further can be performed in parallel at runtime.

Responsive to determining that the decision mode is human centered, the system can prompt the user to specify the list of activities to be presented to the end-user of the business process at runtime in coordination with, e.g., concurrently with, the result from the decision service. The system further can prompt the user whether additional data entry fields are to be presented to the end-user with the list of activities allowing the end-user, at runtime of the business process, to provide an explanation of the particular activity, or activities, that the user is selecting and/or the reason for the selection through manual data entry by the end-user. As noted, each of the activities specified in step 330 can be presented to the end-user at runtime of the business process as selectable options. Further, more than one of the activities can be selected by the end-user at runtime unless the developer of the business process has restricted selection of activities to one or particular ones of those presented during this processing step.

It should be appreciated that with both the logical mode and the recommendation mode, the business process can consume, e.g., use or interpret, the result from the decision service automatically at runtime without a human being selecting the activity or activities that are to be performed. Thus, while the developer of the business process specifies various options that may be available for each decision mode, the end-user of the business process at runtime is involved in selecting a particular set of one or more activities to be implemented at runtime only for the human centered mode decision services. In the case of both logical and recommendation decision modes, the business process interprets the result of the decision service automatically through execution of the business process without requiring a human being to make a selection.

In step 335, the system can receive the activity selection information as described above from the user. It should be appreciated that the particular interface, whether graphical or not, that is presented that allows a user to specify the activity selection information is not intended to be limited by the particular examples provided. Any of a variety of different interfaces can be presented that display available activities of the business process, allow the user to select among those activities for association with the decision to be made, and potentially correlate the selected activities with a result (particular value of the result) returned by the decision service to be implemented as described.

In step 340, the system optionally can receive further user input specifying one or more additional attributes of the decision service. For example, any of the various attributes described with reference to FIG. 1 and the decision description file, i.e., the description including the decision type, vocabulary, etc., can be specified by the user through the presented interface. In step 345, the system optionally can receive the one or more additional attributes if specified by the user.

In step 350, responsive to receiving the attributes or a user instruction that the description of the decision reference is complete, the system can correlate the attributes with the decision reference. For example, the system can create an association between the attributes, which include the decision mode, and the decision reference. In step 355, the system can generate and output a decision description file for the decision reference inserted into the business process. As used herein, the term “output” or “outputting” can mean storing in a memory, providing, e.g., transmitting, sending or publishing, to another computing system, displaying, or the like.

It should be appreciated that while the decision mode is an attribute that can be included in the decision description file as discussed, the decision mode represents a special case of an attribute. In particular, the decision mode, unlike other attributes specified in the decision description file, is used by the BPD tool during the development process to interact with the user and guide the collection of activity selection information as discussed. Other ones of the attributes are provided to the decision service tool or developer largely for the purpose of developing the decision service, but are not utilized by the BPD tool during development of the business process.

In step 360, the system can generate and output the business process. It should be appreciated that while method 300 illustrates the creation of a description for a single decision service, the process can be repeated as needed for creating one or more additional decision service descriptions. Accordingly, the resulting output from the system can include a business process and a complete description, e.g., decision description file specifying the previously noted attributes, for each decision reference and corresponding decision service to be developed.

In general, the system configured to implement method 300 can generate an output, e.g., a business process, in a variety of different programmatic forms. In some cases, for example, the business process can be specified using a markup language that can be interpreted and emulated by a runtime simulation engine. In other cases, the business process can be output in the form of executable program code. In either case, the business process can be executed to emulate the actual business procedures modeled by the business process.

In another aspect, the particular decisions that are defined using the BPD tool can be exposed or otherwise made visible to users. For example, during development of the business process, the system can support querying of decision data by the user. As decisions that are needed by the business process are documented through creation of decision references and the association of attributes with the decision references, a user can query the system using any of the various attributes described. For example, the user can query for any or all decision references associated with a particular mode, having a particular name, or any other combination of attributes previously described. The query functionality provided by the BPD tool allows a business process developer to obtain detailed information about the various decisions that are being used in implementing the business process.

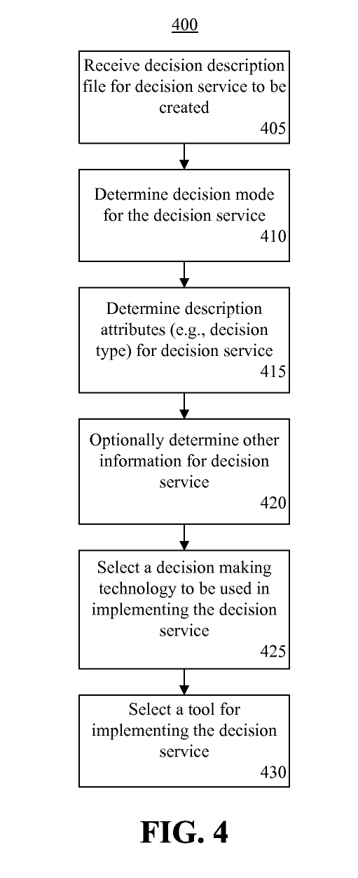

FIG. 4 is a flow chart illustrating a method 400 of managing decision service creation in accordance with another embodiment disclosed within this specification. Method 400 can be implemented by a data processing system as described with reference to FIG. 2. In one example, method 400 can be implemented by a data processing system executing a BPD tool as described with reference to FIG. 1. In another example, method 400 can be performed by a data processing system executing a selection module.

In step 405, the system can receive a decision description file for a decision service that is to be created. In step 410, the system can determine the decision mode attribute for the decision service from the decision description file. In step 415, the system can determine one or more attributes from the description portion of the decision description file. For example, the system can determine a decision type attribute from the description portion of the decision description file. In step 420, the system can obtain any other information, e.g., additional attributes, that may be included in the decision description file or included in the form of metadata accompanying the decision description file.

In step 425, the system can select a particular decision making technology to be used in implementing the decision service. For example, when the decision description file indicates that the type is either opportunity-based or risk-based, a predictive analytics type of decision making technology can be selected. When the decision description file indicates that the type is compliance, for example, a business rules decision making technology can be selected.

In step 430, the system optionally can select a particular tool to implement the decision service according to the particular decision making technology selected in step 425. For example, the system can store correlations between one or more specific decision service tools and the underlying technology utilized by each tool thereby facilitating a selection of a particular decision service tool.

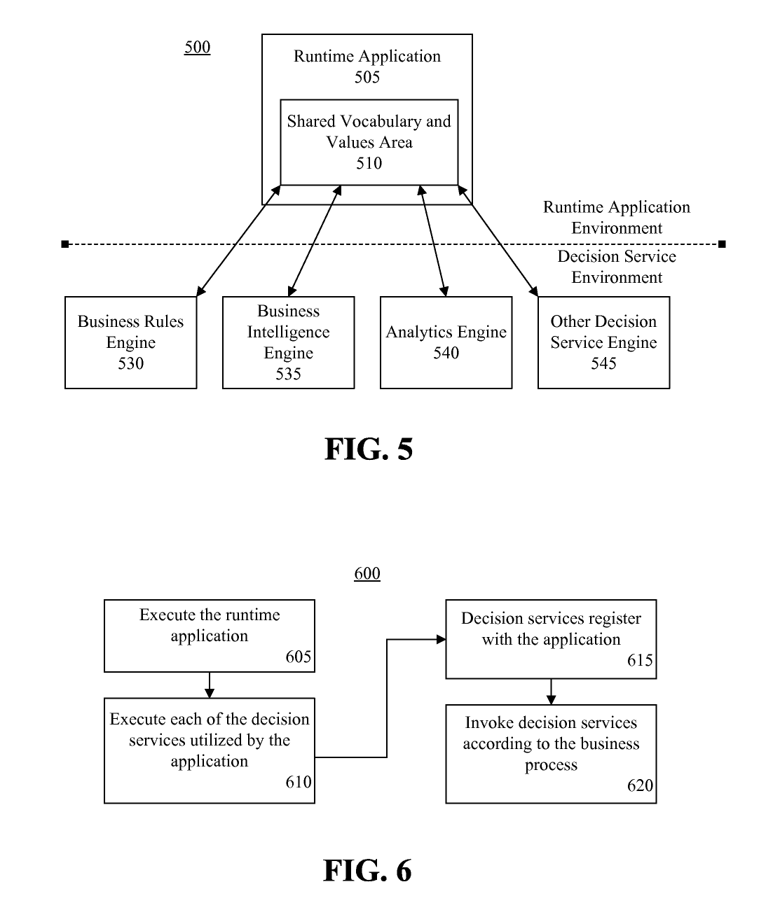

FIG. 5 is a block diagram illustrating an architecture for application runtime in accordance with another embodiment disclosed within this specification. Whereas FIGS. 1, 3, and 4, for example, dealt with development, FIG. 5 illustrates a runtime architecture for implementing the business process and utilizing the decision services once developed. As shown, a runtime application 505 can be executing in a runtime application environment. In one aspect, runtime application 505 can be an emulation engine, e.g., a business process engine, configured to execute a business process generated by BPD tool 105 of FIG. 1, e.g., execute or interpret a markup language application or other programmatic description specifying the business process. In another aspect, runtime application 505 can be the business process specified in executable form, e.g., as an application that can execute without the aid of a business process engine or other runtime engine.

Within the decision service environment, one or more decision service engines can be executing. For example, the decision service environment can include a business rules engine 530, a business intelligence engine 535, an analytics tool engine 540, and one or more other decision service engines represented by block 545. As discussed with reference to FIG. 1, each environment can represent a different and independent computing system or collection of computing systems. Thus, the runtime application environment can be separate and independent of the decision service environment.

During runtime, runtime application 505 implements the business process developed as described with reference to FIGS. 1-3. Runtime application 505 can invoke the appropriate decision services referenced within the business process in accordance with the defined business process. Each of engines 530-545 can be tailored or optimized to implement a particular type of decision making technology. Accordingly, business rules engine 530 is configured to execute or implement decision services built upon one or more business rules. Business intelligence engine 535 is configured to execute or implement decision services built upon business intelligence. Analytics engine 540 is configured to execute or implement decision services built upon analytics, etc.

It should be appreciated that the particular engine that is used is not necessarily correlated with the decision mode of the decision service that is implemented. For example, analytics tool engine 540 can implement a logical mode decision service, a recommendation mode decision service, or a report mode decision service. By implementing decision services independently of runtime application 505, each decision service can be maintained independently allowing the decision service to be updated, changed, or the like without having to re-deploy or otherwise affecting runtime application 505.

Runtime application 505 can invoke decision services using a variety of different methods. In one aspect, not illustrated in FIG. 5, runtime application 505 can call a name of a decision service (e.g., the name of the decision reference and the decision service) and pass a data payload, e.g., an explicit list of parameters, to the invoked decision service. In such an embodiment, the decision service that is called from the business process receives the information needed for implementing the decision from the business process.

In another aspect, runtime application 505 can invoke a decision service by calling the service name and passing an instance pointer that specifies a memory location in shared vocabulary and values area 510, e.g., in shared memory. The instance pointer can be used in lieu of passing an explicit list of parameters. The decision service can use the instance pointer to retrieve one or more instance data fields as per need of the implementation of the invoked decision service. The decision service can utilize only those values that are needed and ignore the remaining data.

In still another example, runtime application 505 can call a particular decision service by name and pass a context identifier, e.g., a process identifier. The decision service that is invoked can obtain any information that may be required during execution through access to runtime application 505 or another data source coupled thereto.

For example, the decision services can utilize a standard application programming interface (API) provided by runtime application 505 or a database utilized by runtime application 505 from which the decision service can obtain any additional data that may be required to perform the needed decision making. The instance pointer can indicate a location in memory at which relevant data for the decision to be made is stored, e.g., customer identification number, etc. If further information is needed, the decision service can utilize the API with the data obtained via the instance pointer. This further decouples implementation of the decision service from the business process.

In illustration, consider the prior example in which an insurance claim is being processed and a decision service is called to determine whether there is potential deceptive activity associated with the insurance claim. In this example, shared vocabulary and values area 510 can store limited information such as a customer identifier (e.g., name or account number) and a claim number for the particular claim being processed.

Using the API, the decision service can obtain any additional information that may be needed from the system that is not included in shared vocabulary and values area 510. For example, details about the insurance claim can be retrieved using the API and the claim number. Prior claim history for the customer can be obtained. Statistical data relating to other like claims of other customers can be retrieved, etc., as may be required to perform the expert decision making implemented by the decision service. In general, the decision service obtains any information needed to make the decision. The business process, e.g., runtime application 505, however, need only pass a general reference to the claim being processed and otherwise can remain unaware of the other additional information potentially required by the decision service to determine a result that is passed back to runtime application 505.

FIG. 6 is a flow chart illustrating a method 600 implementing a business process in accordance with another aspect disclosed within this specification. Method 600 illustrates a runtime method relating to execution of the business process and the decision services as illustrated with reference to FIG. 5.

In step 605, the runtime application can be executed within a data processing system. In step 610, the each of the services utilized by the business process can be executed within a data processing system, e.g., a different data processing system and runtime environment as described. In step 615, each of the decision services can register with the runtime application. In step 620, the runtime application can invoke the decision services as required in accordance with the business process being executed. It should be appreciated that while the decision services are instantiated, e.g., executed, in step 610, the decision services are not invoked, e.g., called, by the business process until step 620 per the business process being executed. Any of the various techniques for passing data to the decision service and a result back to the runtime application can be used.

In another aspect, the runtime application can expose decisions, or otherwise make decisions available, to end-users or others at runtime. The runtime application, e.g., the business process engine or the like, can be configured to automatically maintain an audit trail of business decisions that are made by the business process, e.g., runtime application 505. In general, an “audit trail” refers to a means, e.g., recorded transactions or a log, for tracing items of data from processing step to step, particularly from a machine-produced report as from a decision service and/or the business process or other machine output back to the original data. For example, one or more or all of the activities performed, results of activities, selected paths, etc., can be persisted automatically during runtime for subsequent evaluation and/or sharing. In addition, any results returned by a decision service and used by the business process can be persisted.

In illustration, when a particular business decision is made, a user can review the audit trail associated with that business decision. Each of the smaller business decisions, including results of decision services, activities, selected paths, etc., can be reviewed to determine why a particular business decision was made, e.g., why an insurance claim was denied, or the like. Referring to the decision services, for example, the result, whether a logical result, a recommendation, or a report, also can be persisted.

In one aspect, particularly in the case of a human centered mode decision service, the runtime application can be configured to receive annotations from the user reviewing the report and making a decision. As discussed, a report mode decision service can return a report that is evaluated by a user. The user can be presented with one or more options as part of the business process in conjunction, e.g., concurrently, with the report from the decision service. The user can, for example, add annotations detailing the reasons why the user is selecting a particular option based upon the data included in the report. Such annotations can be persisted with the decision service result as part of the audit trail for the business decision that is being made. It should be appreciated that within the audit trail, different types of data can be differentiated as being a decision service result, data or an annotation entered by a user, a business process decision, or the like. Thus, end-users can query the audit information and use various parameters to do so such as return decision service results, return end-user annotations, etc.

It should be appreciated that the runtime application can be configured to maintain an audit trail automatically for business decisions that are made without the developers of the business process having to explicitly code such functionality. For example, in the case of a business process engine or other runtime environment that is configured to execute a business process, the business process engine can be configured to maintain the audit trails automatically without the particular business process being executed having been designed to generate the audit trail.

The embodiments disclosed within this specification provide a decision management layer for managing business decisions that separates a clear definition of the business user requirements for business decisions and consumption of these business decisions in the business applications from the management of the business decisions (i.e., the selection and implementation using analytic tools by the experts). This allows the experts to focus on implementing the requirements for managing business decisions, rather than the overall business applications. Further, decoupling the implementation of the decision services from the business processes reduces the need to change the decision services when changes to the business process are introduced. Similarly, implementation of a decision service can be changed without having to implement changes in the business process.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “include” and/or “including,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

1-8. (canceled)

9. A system, comprising:
a processor configured to initiate executable operations comprising:
generating a decision reference at an insertion point within a business process; associating, using a processor, the decision reference with one of a plurality of different decision modes;
wherein each decision mode indicates a different process for selecting one or more activities of the business process to be performed according to a result of a decision service to be implemented for the decision reference; and
generating a decision description file for the decision reference specifying, at least in part, the associated decision mode.

10. The system of claim 9, wherein the processor is further configured to initiate an executable operation comprising:
selecting the decision mode to be a logical mode that returns the result in binary format to the business process;
wherein the business process is configured to select one of two alternative paths according to the value of the result.

11. The system of claim 9, wherein the processor is further configured to initiate an executable operation comprising:
selecting the decision type to be a recommendation that returns the result as a value within a defined range to the business process;
wherein the business process is configured to interpret the value by comparing the value to at least one segment of the defined range and select at least one activity to be performed according to the comparison.

12. The system of claim 9, wherein the processor is further configured to initiate an executable operation comprising:
selecting the decision mode to be human centered;
wherein the business process is configured to present at least two options concurrently with the result and receive a user selection of at least one of the options.

13. The system of claim 9, wherein the processor is further configured to initiate an executable operation comprising:
responsive to a user initiated query, providing a list of at least one decision reference of the business process that conforms with the query.

14. The system of claim 9, wherein the processor is further configured to initiate an executable operation comprising:
selecting a decision making technology according to at least one attribute specified within the decision description file.

15. The system of claim 14, wherein the processor is further configured to initiate an executable operation comprising:
selecting a decision service tool according, at least in part, to the selected decision making technology.

16. The system of claim 9, wherein the processor is further configured to initiate an executable operation comprising:
storing an audit trail of the business process comprising the result of the decision service at runtime.

17. A computer program product, comprising:
a computer readable storage medium having stored thereon program code that, when executed, configures a processor to perform executable operations comprising:
generating a decision reference at an insertion point within a business process; associating, using a processor, the decision reference with one of a plurality of different decision modes;
wherein each decision mode indicates a different process for selecting one or more activities of the business process to be performed according to a result of a decision service to be implemented for the decision reference; and
generating a decision description file for the decision reference specifying, at least in part, the associated decision mode.

18. The computer program product of claim 17, wherein the computer readable storage medium further comprises program code that configures the processor to perform an executable operation comprising:
selecting the decision mode to be a logical mode that returns the result in binary format to the business process;
wherein the business process is configured to select one of two alternative paths according to the value of the result.

19. The computer program product of claim 17, wherein the computer readable storage medium further comprises program code that configures the processor to perform an executable operation comprising:
selecting the decision type to be a recommendation that returns the result as a value within a defined range to the business process;
wherein the business process is configured to interpret the value by comparing the value to at least one segment of the defined range and select at least one activity to be performed according to the comparison.

20. The computer program product of claim 17, wherein the computer readable storage medium further comprises program code that configures the processor to perform an executable operation comprising:
selecting the decision mode to be human centered;
wherein the business process is configured to present at least two options concurrently with the result and receive a user selection of at least one of the options.

21. The computer program product of claim 17, wherein the computer readable storage medium further comprises program code that configures the processor to perform an executable operation comprising:
responsive to a user initiated query, providing a list of at least one decision reference of the business process that conforms with the query.

22. The computer program product of claim 17, wherein the computer readable storage medium further comprises program code that configures the processor to perform an executable operation comprising:
selecting a decision making technology according to at least one attribute specified within the decision description file.

23. The computer program product of claim 17, wherein the computer readable storage medium further comprises program code that configures the processor to perform an executable operation comprising:
selecting a decision service tool according, at least in part, to the selected decision making technology.

24. The computer program product of claim 17, wherein the computer readable storage medium further comprises program code that configures the processor to perform an executable operation comprising:
storing an audit trail of the business process comprising the result of the decision service at runtime.
